(19) United States
(12) Patent Application Publication
(10) Pub. No.: US 2012/0121077 A1
(43) Pub. Date: May 17, 2012

(54) SYSTEM AND METHOD FOR BROKERING COMMUNICATION DEPENDENT TASKS

(75) Inventors: Gil Gabay, Herzlia (IL); Hezi Stern, Even Yehuda (IL); Ran Mochary, Nes Ziona (IL)

(73) Assignee: Delegate Communications Ltd., Mobile Post Hefer (IL)

(21) Appl. No.: 13/381,993

(22) PCT Filed: Jul. 4, 2010
(86) PCT No.: PCT/IB10/53062

§ 371 Date: Jan. 3, 2012

Related U.S. Application Data
(60) Provisional application No. 61/223,050, filed on Jul. 5, 2009.
(60) Provisional application No. 61/304,453, filed on Feb. 14, 2010.

(51) Int. Cl. H04M 3/42; G06F 15/173; G06F 15/16; G10L 15/00

(52) U.S. Cl. 379/211.02; 379/201.01; 709/223; 709/206; 704/E15.001

(57) ABSTRACT

A method implementable on a computing device for brokering communication dependent tasks (CDTs) includes receiving at least an indication of a requested CDT from a user, associating the request with at least one pre-defined CDT scenario, determining at least an appropriate time and means for communications for contacting at least one party based on the CDT scenario, and contacting the party on behalf of the user.

### CROSS REFERENCE TO RELATED APPLICATIONS

This application claims priority benefit from U.S. Provisional Patent Applications No. 61/223,050, filed Jul. 5, 2009, and 61/304,453, filed Feb. 14, 2010, which are hereby incorporated herein by reference in their entirety.

### FIELD OF THE INVENTION

The present invention relates to communicating generally and to the completion of communication dependent tasks in particular.

### BACKGROUND OF THE INVENTION

People execute tasks on a daily basis. A large proportion of these tasks are Communication Dependent Tasks (CDTs) for which completion is typically dependent on an “A-party” (the user responsible for the CDT) communicating with a “B-party” in order to complete the CDT. A B-Party may be either human or a virtual entity (e.g. a web site or a web service) and may be comprised of more than one B-Party. Common examples of such CDTs include: getting hold of the B-party on the phone (arranging a phone call with a person); ensuring that the B-party receives/reads an SMS; receiving a response to a query sent via asynchronous communication method like voicemail, email, instant messaging (IM), social/professional network applications (such as Facebook, Twitter and LinkedIn) or SMS; traversing an IVR system until a live service representative is reached; reserving a table at a restaurant; scheduling a doctor appointment; etc.

Most people execute and manage the multi-step nature of such CTDs by themselves. They use different communication devices and modalities, such as voice calls over a mobile or landline phone, SMS, Email, instant messaging (IM), VoIP/SIP providers, social networks and web browsers. They establish communication with the relevant B-parties, monitor the execution progress, handle issues and decision points along the way, and finally bring tasks to completion. CDTs often become multi-step transactions which spread over extended time periods. Such CDTs require increased management effort and sustained attention resulting in open loops (open tasks). This increased effort and attention is one of the main reasons people tend to drop or forget CDTs before bringing them to completion.

Some services assist with executing tasks. Such services are offered for example by a personal assistant, a secretary, or by service companies of virtual assistants like AskSunday (http://www.asksunday.com/). Such services are human-based, and have not gained significant penetration into the mass market due to their relatively high cost.

One of the basic CDTs is the establishment of a direct communication link between A-party and B-party or B-parties, such as a phone call or a conference call. One of the important measures relevant for this CDT is call completion rate, which is the percentage of phone calls getting answered. Call completion rate is commonly estimated in the telecommunications industry around 70%. Since call completion rate is coupled with carrier revenues, there have been many attempts to develop solutions that increase call completion rate. One example is a solution from Comverse, which alerts callers via SMS when a previously unreachable party (e.g. the target cell phone was off or out of range, the target line was busy etc.) becomes reachable (http://www.comverse.com/call_completion).

Other systems for increasing call completion rely on telecom signaling and presence information, and there are some patents related to selecting the appropriate communication channels and modalities between the parties (for example U.S. Pat. No. 6,771,756 by IBM, U.S. Pat. No. 7,389,351 by Microsoft, and U.S. Pat. No. 7,483,525).

### SUMMARY OF THE INVENTION

There is provided, in accordance with a preferred embodiment of the present invention, a method implementable on a computing device for brokering communication dependent tasks (CDTs), the method including: receiving at least an indication of a requested CDT from a user; associating the request with at least one pre-defined CDT scenario; determining at least an appropriate time and means for communications for contacting at least one party based on the CDT scenario; and contacting the party on behalf of the user.

Further, in accordance with a preferred embodiment of the present invention, the at least one party is at least one of a human being and a computer service.

Still further, in accordance with a preferred embodiment of the present invention, the contacting is via use of at least one of speech and text dialog over one of voice and data communication channels.

Additionally, in accordance with a preferred embodiment of the present invention, the contacting includes scheduling communication with the party, where the scheduling is a product of negotiation with at least the party.

Moreover, in accordance with a preferred embodiment of the present invention, the data communication channel is at least one of a social network, an SMS, an email, an IM, and voice over IP.

Further, in accordance with a preferred embodiment of the present invention, the method also includes connecting the user and the party in a telephone call, where the CDT scenario is to connect a telephone call between the user and the party.

Still further, in accordance with a preferred embodiment of the present invention, the CDT scenario is to query the party on behalf of the user.

Additionally, in accordance with a preferred embodiment of the present invention, the CDT scenario is to inform the party regarding something on behalf of the user.

Moreover, in accordance with a preferred embodiment of the present invention, the contacting includes at least two means for communication.

Further, in accordance with a preferred embodiment of the present invention, the contacting includes: presenting a question to the party, interpreting a response received from the party, determining whether or not an end condition has been met; modifying the presenting as necessary according to at least a result of said determining; repeating said asking, interpreting, determining and modifying until said end condition has been met; and performing a next communication step on behalf of the user, where the next communication step is at least one of scheduling another instance of the contacting, the contacting with a different question, the contacting with different means for communications, forwarding at least an indication of the response to said user, and connecting the user and the party in a telephone call.

Additionally, in accordance with a preferred embodiment of the present invention, the interpreting includes at least one of speech interpretation and text interpretation.

Still further, in accordance with a preferred embodiment of the present invention, the determining also includes scheduling the contacting in accordance with at least one of a set of preferences associated with the user and the CDT scenario.

Additionally, in accordance with a preferred embodiment of the present invention, the scheduling also includes determining a desired context for the user.

Moreover, in accordance with a preferred embodiment of the present invention, the desired context is at least one of a location, a phone profile configured on a device associated with the user, and a calendar entry on a calendar associated with the user.

There is also provided, in accordance with a preferred embodiment of the present invention, a method implementable on a computing device for facilitating communication dependent tasks (CDTs), the method including: defining at least one CDT scenario for a user, where the CDT scenario entails at least communication with a party to be contacted, where the communication is via at least one of voice and data; requesting the CDT scenario to be performed in association with at least one specific party; and forwarding the requested CDT scenarios to a CDT server for processing.

Further, in accordance with a preferred embodiment of the present invention, the requesting is initiated on a communications device from within at least one of a native contacts application, a native dialer application, a native phone application, and a native calendar application.

Still further, in accordance with a preferred embodiment of the present invention, the forwarding includes user context updating, where the updating is at least one of providing location data from a location based service (LBS) on a device associated with the user; providing an indication of a phone profile on a communications device associated with the user; providing calendar information from a calendar associated with the user; and providing presence indicating information from an application associated with said user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel CDT brokerage system, constructed and operative in accordance with a preferred embodiment of the present invention;

FIGS. 2A and 2B are a schematic illustration of a novel CDT customer devices to be used within the system of FIG. 1;

FIG. 2C is a schematic illustration of an exemplary configuration of one of the devices of FIGS. 2A and 2B;

FIG. 3 is a schematic illustration a novel CDT server to be used within the system of FIG. 1;

FIG. 4 is a block diagram that illustrates an exemplary process for processing conversation based tasks by elements of the CDT server of FIG. 3;

FIG. 5 is a schematic illustration of an alternative preferred embodiment of the CDT server 200 of FIG. 3;

FIGS. 6A-C are block diagrams that illustrate exemplary processes performed by the CDT servers of FIGS. 3 and 5;

FIG. 6D is a schematic illustration of an exemplary preferred configuration of the system of FIG. 1;

FIG. 7 is a schematic illustration of an exemplary deployment 500 of the system of FIG. 1 with respect to voice dialog capabilities; and

FIG. 8 is a schematic illustration of a framework for future development of the system of FIG. 1.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

One of the major drawbacks of the current systems for call completion is that by the time that the B-party becomes available, the A-party might be busy, or the A-party may no longer even remember the reason for the call. And even when a call is established between the two parties, there are many cases where follow-up calls may be necessary. For example, when the B-party responds that it is not a convenient time, asks for another call in a few minutes, or when the parties conduct a conversation in order to set a future time for the call that is convenient for both of them. Such conversations may happen also over a text modality, such as SMS, email, instant messaging (IM) and social & professional networks such as Facebook, Twitter, and LinkedIn, and may happen as a combination of phone calls and text messaging. In such cases, the A-party may need to keep in mind an open loop (open task), and keep managing this task by calling several times until a proper conversation can be made, reaching task completion. As to be expected, oftentimes the A-party will either decide to drop the task, forget it, or forget to make the calls at the right times.

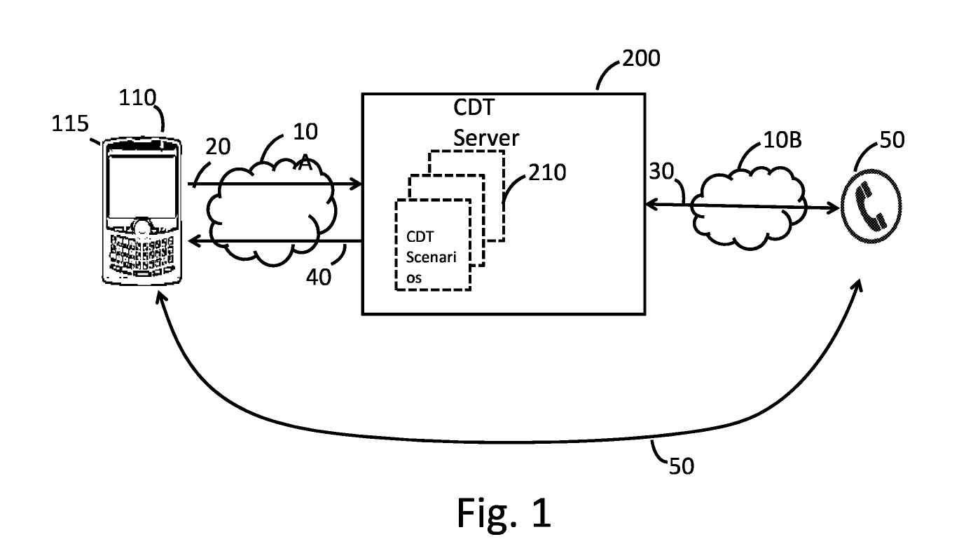

Applicants have realized that an automated, non human dependent, solution may address some of these issues. Reference is now made to FIG. 1 which illustrates a novel CDT brokerage system 100, constructed and operative in accordance with a preferred embodiment of the present invention. System 100 may comprise a CDT server 200 that may communicate with CDT customer device 110 and target communications device 50 via communications networks 10. CDT customer device 110 may be operated by an A-party user that may subscribe to services offered by system 100; whereas device 50 may belong to a B-party with whom the A-party may wish to communicate in the context of a CDT.

CDT server 200 may comprise a series of CDT scenarios 210 that may be employed by the A-party using device 110 to communicate with a B-party using device 50. In accordance with an exemplary preferred embodiment of the present invention, scenario 210 may be a request from the A-party to place a phone call to the B-party. For example, device 110 may comprise a contact application 115 storing the B-party's phone number. The A-party may use an application to send (arrow 20) the phone number to CDT server 200 to effect a connection with the B-party's device 50. It will be appreciated that the A-party may also send to CDT server 200 additional information as necessary, such as, for example, the name of the requested person, and the subject for the call. As per the settings of scenario 210, CDT server 200 may call (arrow 30) device 50 until it may be answered by the B-party. CDT server 200 may conduct a speech dialog with the B-party to check its availability for a call with the A-party according to the specified subject. Once the B-party has confirmed its availability, CDT server 200 may notify (arrow 40) device 110 that the B-party is available for the call. Assuming that the A-party is available and still interested in the call, CDT server may connect devices 110 and 50 for a phone conversation (arrow 60).

In such manner, system 200 may effectively “broker” communications between an A-party and one or more B-parties. System 200 may iteratively contact a B-party on behalf of an A-party until the conditions of a CDT scenario 210 are met, or until a break condition occurs and the CDT may be canceled, postponed or modified. In such manner, System 200 may negotiate with a B-party regarding a time to complete (or at least initiate) a communication that may advance a CDT towards completion. It will be appreciated that system 200 may choose one or more different communication means for each iteration, such as voice call, SMS, email, IM and social networks.

CDT server 200 may use the services of a call control platform to create and join/bridge the calls together. Such a platform may be defined, for example, by the CCXML standard of W3C for call control (http://www.w3.org/TR/ccxml/). The standard may include a section on bridging that may be use to implement the required platform. An example of such a platform implementation may be available from by Voxeo Corporation (www.voxeo.com).

It will be appreciated that the depiction of device 50 as a standard telephone in FIG. 1 may be exemplary. The current invention may include support for any communications able device in use by the B-party, such as a mobile phone, a landline phone, a VoIP phone, a VoIP application etc. For example, the B-party may even have a device 110 similar to that of the A-party. However, it will be appreciated that no non standard equipment may be required; a simple POTS (plain old simple telephone) may be sufficient for device 50.

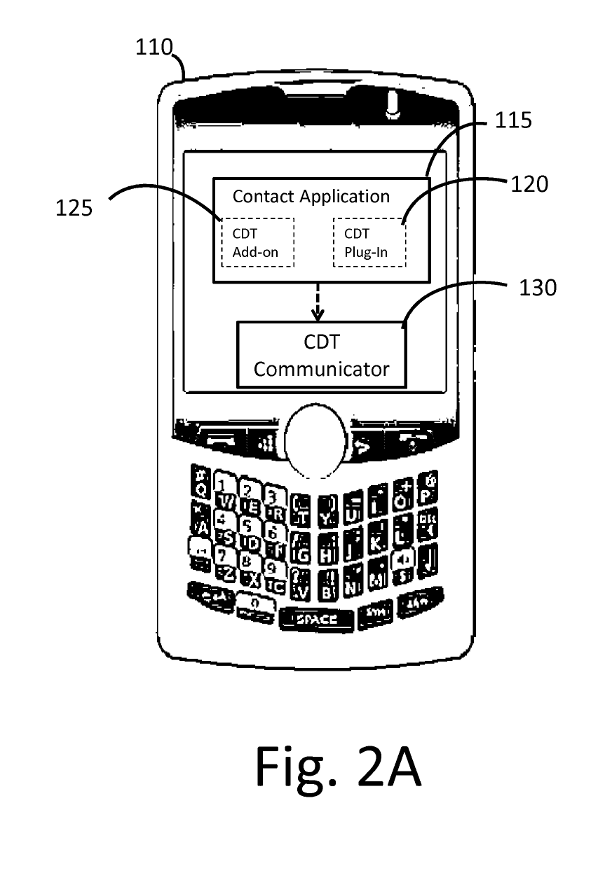

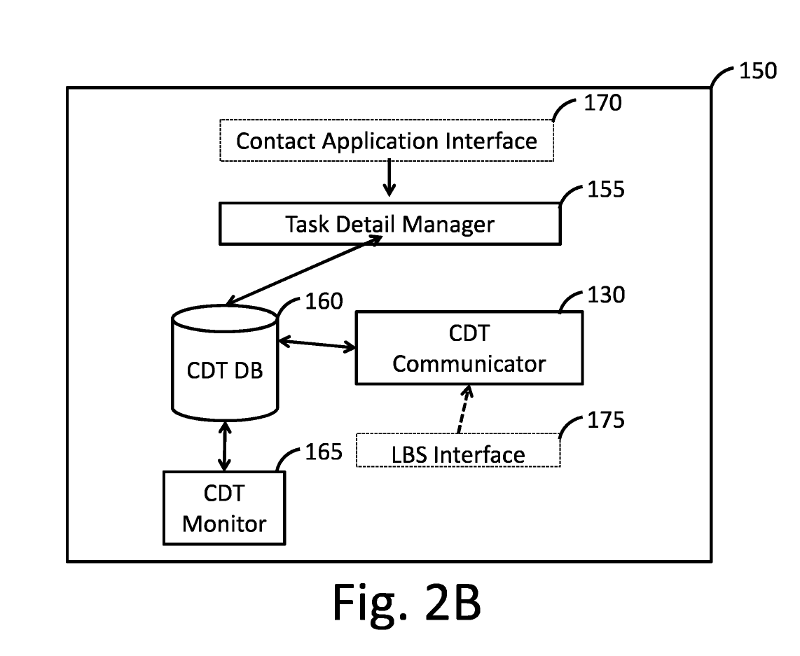

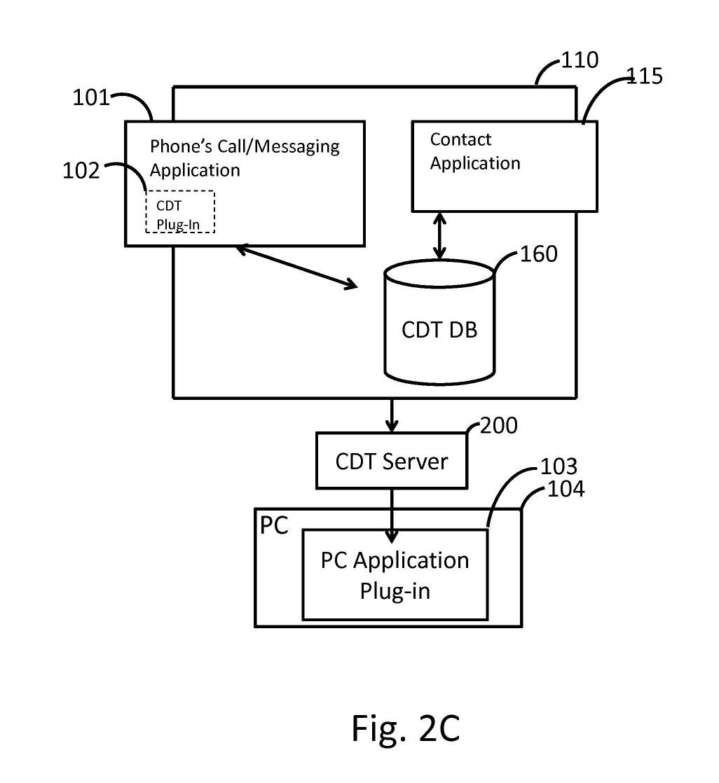

Reference is now made to FIG. 2A, which illustrates a novel CDT customer device 110 constructed and operative in accordance with an exemplary preferred embodiment of the present invention. Device 110 may comprise a contact application 115 and a CDT communicator 130. Contact application 115 may be any suitable application that may be capable of storing contact details, such as a name and phone number, for B-parties that the A-party may wish to contact. In accordance with a preferred exemplary embodiment of the present application, device 110 may be a Blackberry device available from Research In Motion Limited (http://www.rim.com/) and contact application 115 may be a built-in application that may provide the required functionality.

Contact application 115 may provide application programming interfaces (APIs) to enable third party developers to add functionality to the original application. Accordingly, application 115 may comprise one or more CDT plug-ins 120 or add-ons 125 that may be installed in order to implement the present invention.

In accordance with a preferred embodiment of the present invention, plug-in 120 may be implemented as an additional option available from an existing standard contact details menu in application 115. Accordingly, in order to initiate a CDT such as “get the B-party on the phone”, the A-party may first view the B-party's contact details via application 115. An exemplary standard contact details menu in application 115 may include options such as “call”, “edit”, “delete”, etc. CDT plug-in 120 may add a “get/reach” option to invoke a CDT service for “get the B-party on the phone”. Once the “get” option may be selected, plug-in 120 may forward the selected option and relevant contact details to CDT requester 130. CDT requester 130 may then use built-in functionality on device 110 to send the request for processing to CDT server 200 via network 10A. It will be appreciated that such a “get/reach” option may be exemplary; as may be disclosed hereinbelow, the present invention may not be limited to a single task option. For example, other possible menu options may include “inform” and/or “query” which may use text based messaging to send and receive acknowledgements.

In accordance with a preferred embodiment of the present invention, plug-in 120 may be implemented via a new option in a built-in dialer application on device 110. Dialer applications typically support a hang-up option invoked via a hard or soft key option on device 110. Pressing the key after dialing out and/or connecting with the dialed party may disconnect the call. Plug-in 120 may be implemented via a new key or screen option defined for a “delegate” option. When the “delegate” option may be selected, plug-in 120 may stop the outgoing call and may create a new CDT with the details of the outgoing call and default properties (like action=“get a hold of”, time of execution=“in 5 minutes”). The CDT may also be presented on an editable screen for the user to modify/save/cancel. Processing vis-à-vis CDT server 200 may then proceed as disclosed hereinabove.

Similar functionality may be implemented for incoming calls as well. When an incoming call is detected, the built-in phone application usually presents 2 options: “accept” and “reject”. Plug-in 120 may be implemented as a third option: “delegate”. When selecting this option, plug-in 120 may reject the call, and create a new CDT with the details of the caller id or associated contact and default properties and edit options as described hereinabove. The newly created CDT may then be processed by CDT server 200 as in the previous embodiments.

In accordance with a preferred embodiment of the present invention, plug-in 120 may also be implemented as a separate client application, focused around task management, which may allow the user to control and monitor the execution progress of a CDT. An exemplary such application may comprise a dashboard screen, displaying a list of CDTs, their execution status and progress, and additional UI controls and screens for controlling the CDTs (add/delete/postpone/update details). In such cases, choosing the “get/reach” menu option from the contact application 115 may launch the application's input screens, enabling the A-party user to configure several features of the requested operation, such as start time, deadline, urgency, memo, notification method to A-party, and features relevant for the communication with B-party, such as modality (voice/text/both), device (mobile/work), conversation style (polite/succinct/friendly) etc.

FIG. 2B, to which reference is now made, illustrates an exemplary CDT client application 150 constructed and operative in accordance with a preferred embodiment of the present invention. Application 150 may be installed on device 110 and may comprise CDT communicator 130, task detail manager 155, CDT database 160 and CDT monitor 165.

CDT communicator may provide generally the same functionality as in the embodiment of FIG. 2A, to send and receive data to server 200. Task detail manager 155 may comprise the logic necessary to input the details of a given task as per the examples disclosed hereinabove. It will be appreciated that that manager 155 may be invoked explicitly by a user to add or modify a CDT. However, manager 155 may also be invoked from a contact list application 115 as disclosed hereinabove, as well as from any other application relevant for communication and tasks, such as, for example, the call log and the calendar application. Contact application interface 170 may provide the functionality necessary to receive contact information and/or CDT related requests from application 115 and/or other relevant communication/task management applications.

It will be appreciated that application 150 may also comprise a standalone list of contacts separate from that of application 115. Furthermore, in accordance with a preferred embodiment of the present invention, application 150 may also use communicator 130 to access a similar list of contacts located and maintained on server 200. In accordance with yet another preferred embodiment of the present invention, application 150 may access a call log on device 110 and/or previous CDT history from CDT database 160 to provide an alternative list of contacts and/or to augment an existing such list (such as provided by application 115). Accordingly, application 150 may not require access to application 115 in order to operate.

Task detail manager 155 may store CDT details in CDT database 160. CDT communicator 130 may read these details and forward requests accordingly to server 200 for processing. CDT communicator 130 may also update CDT database 160 from time to time with the status of CDTs as received from server 200. CDT monitor may provide a visual GUI display with the current status of relevant CDTs. It will be appreciated that the relevant CDTs may be grouped and displayed according to a variety of status criteria including: time to next execution, active/non-active/completed, contact name, time stamps, etc.

Applicants have realized that devices 110 may typically be equipped with location based services (LBS) functionality. Such functionality may be leveraged to provide CDT services based on a “current context” of the user, i.e. the current location of the A-party user. Accordingly, LBS interface may forward location data to communicator 130 from time to time. Communicator 130 may forward the location data to server 200 for the purpose of determining when/how a given CDT may be completed. For example, the A-party may define a CDT parameter to wait until device 110 may be determined to be moving along a long stretch of highway on the way home before attempting to reach the A-party's spouse.

It will be appreciated that such delayed execution may be an important feature of the current invention. For example, the user may enter a CDT with a future starting time, such as “get a hold of Harry tomorrow morning after 0900”, or “get a hold of a Comcast service representative after receiving the bill on February 1^{st} to dispute a charge for a VOD movie that was dropped in the middle today (January 12)”. Server 200 might also be configured to add information relevant for CDT execution, such as working hours for service representatives. It will be similarly appreciated that CDTs may also be recurring in nature, for example: “get a hold of my spouse every working day while I am commuting from/to work”

It will also be appreciated that the CDT client application 115 may be also triggered by other means, such as, for example, an application shortcut or dedicated key.

It will be appreciated that application 115 may include functionality for context-related/context-aware pop-up of relevant information regarding an active CDT. Reference is now made to FIG. 2C which illustrates an exemplary configuration for such context based CDT pop-up reminders. Device 110 may comprise a conversation application 101. It will be appreciated that application 101 may be any suitable communications application that may typically be installed on a device such as device 110. For example application 101 may be a native phone application or an IM application. Application 101 may be augmented with CDT plug in 102 which may be configured to check the contact details of parties in conversation with device 110.

In accordance with an exemplary preferred embodiment of the present invention, when the A-party dials a contact/number, plug-in 102 may access CDT DB 160 to establish whether or not an ongoing CDT exists for the conversation's partner. If the other party may be associated with an active CDT, a pop-up message may appear, reminding the A-party about information from the relevant CDT. For example, the A-party may have a CDT to ask a spouse to buy milk. When the user calls the spouse, or receives a call, a pop-up message may appear, reminding the user to discuss the open task of milk. This feature may be also incorporated when sending or receiving SMS, or any other method of communication with a contact.

Such CDT related popup messages may not be limited to the actual calling device, but may also appear at generally the same time via other media, such as the A-party's PC 104. For example, the A-party may register the details of applications in use on PC 104 in the office. The present invention may comprise, for example, an outlook add-on such as PC application plug-in 103 or a stand-alone application configured to receive the popup message from CDT server 200 when such a call is detected on device 110. Server 200 may use location-based information from the device to determine where to display the pop-up message. For example, if device 110 is at work, the pop-up will be displayed on the workstation via plug-in 103, and when the device is at home, the pop-up will be displayed on the home PC. Alternatively plug-in application 103 may be configured to provide location based information by periodically updating CDT server whenever it is in use.

It will be appreciated that in such manner, the present invention may also be configured to provide services to the A-party without necessarily involving a B-party. The present invention may also include “own party CDTs” where A-party may take advantage of the invention's multi-platform interaction capabilities to send themselves reminders. For example, during breakfast at home, an A-party may use device 110 to send herself a reminder to pick up a carton of milk on the way home. At 5:00 PM a pop-up message may appear on the A-party's computer screen at work (via, for example, an Outlook add-on) with the reminder.

It will further be appreciated that the task application itself may also contain contact information on the device, and also receive updates from the server, for example a list of businesses to reach.

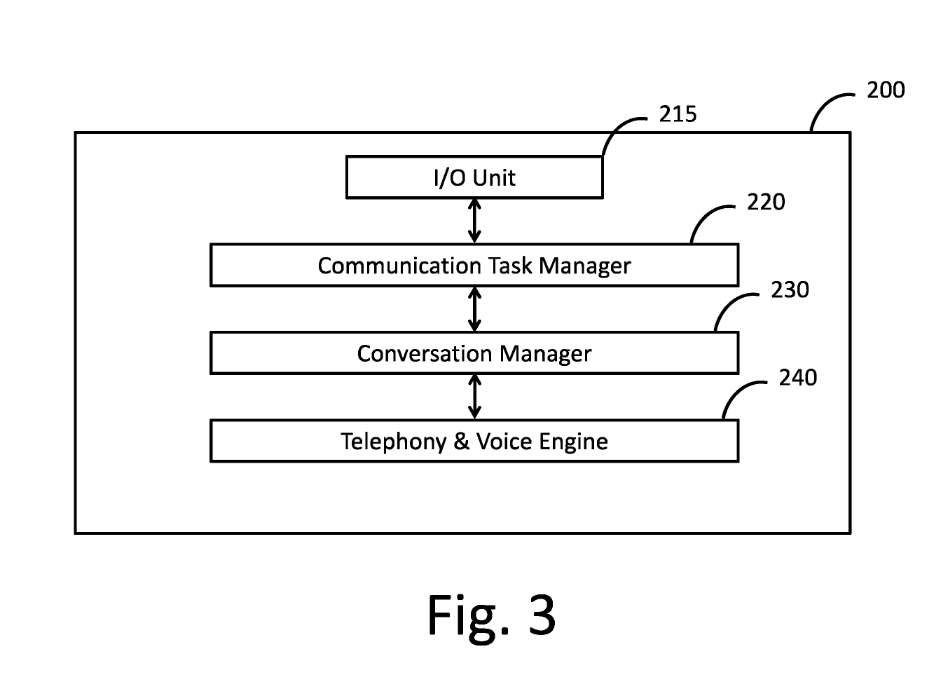

FIG. 3, to which reference is now made, illustrates a novel CDT server 200 in accordance with an exemplary preferred embodiment of the present invention. Server 200 may comprise communication task manager 220, conversation manager 230 and telephony & voice engine 240.

Communication task manager 220 may receive the CDT request from CDT communicator 130 via I/O unit 215, such as a web server communicating with A-party user via a client application 150, or via a web-interface. It will be appreciated that the receipt of the CDT request from CDT communicator may be exemplary; I/O unit 215 may be configured to communicate via a variety of other communications means, such as, for example, email, SMS, IM, social networks, or even voice requests.

It will be appreciated that in accordance with the number of CDT scenarios 210 defined on CDT server 200, there may be many different types of such requests that manager 220 may receive from time to time. Accordingly, communications task manager 220 may first interpret the request before assigning it for processing. As per the exemplary embodiment of FIGS. 2, the request may be “get the B-party on the phone”. In such a case, manager 220 may assign the request for further processing to conversation manager 230.

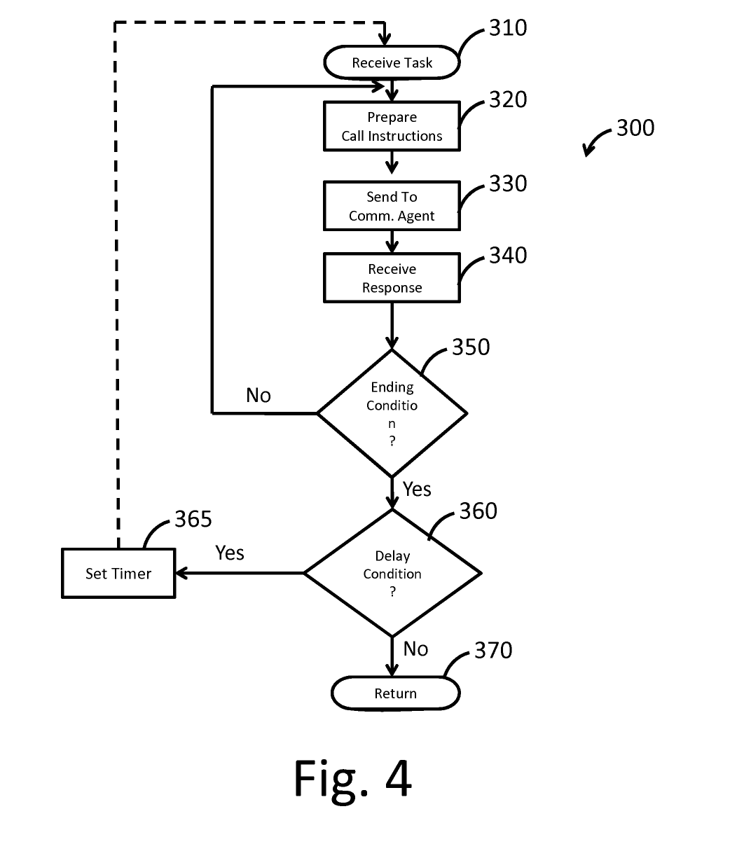

FIG. 4, to which reference is now made, illustrates an exemplary process 300 for processing of conversation based tasks by conversation manager 230. Manager 230 may receive (step 310) a task from manager 220 such as a “get the B-party on the phone” CDT as discussed hereinabove. Such a CDT may comprise a number of sub-tasks, such as, for example, “dial the B-party”, “request to speak with the B-party”, “interpret the received voice response”, etc. Conversation manager 220 may prepare (step 320) call instructions specific to these sub-tasks. For example, manager 220 may include the B-party's phone number and indicate the “script” to be used for the conversation. It will be appreciated that other parameters may also be included based on the nature of the task, such as voice style/characteristics to use (e.g. female, slow pace, polite conversation).

Conversation manager 230 may send (step 330) the call instructions to an appropriate communications agent for processing. The communications agent may be an engine, sub-routine or module that may be appropriate for the indicated type of communication. For example, in the embodiment of FIG. 3, telephone & voice engine 240 may be the communications agent appropriate for the task of “gets the B-party on the phone”. Engine 240 may attempt to initiate a voice conversation with the B-party's device 50. Engine 240 may comprise of variety of speech recognition products and utilities such as known in the art in order to conduct a voice or DTMF dialogue with the B-party. It will be appreciated, as will be disclosed hereinbelow, that other communications agents may be included in the present invention.

Conversation manager 230 may then receive (step 340) a response from the relevant agent, for example, engine 240. It will be appreciated that manager 230 may enter a wait state while waiting for the response. The response may consist of a simple yes or no response from the B-party regarding availability. Alternatively, the response may simply be that a busy signal was received or that the phone wasn't answered, or even that an answering machine or voicemail system answered the call. The response may also be that the B-party is presently busy but would appreciate a call at a later time. It will be appreciated that there may be other responses as well for conversation manager 230 to interpret.

Manager 230 may determine (step 350) whether or not an ending condition may have been met based on the response received from engine 240. For example, if the B-party said “yes, I′m available for a call”, or “call me back in 5 minutes”, an ending condition may be met and processing may continue to step 360. Non ending conditions may include, for examples, incoherent responses or requests to repeat the question. In such cases, processing may return to step 320, and manager 230 may prepare a modified set of instructions as per the response.

Depending on the requirements of the relevant CDT scenario 210, other responses may trigger conversation manager 230 to elicit new information from the B-party. For example, the B-party's response may be “not now, I′m leaving the office.” The relevant CDT scenario 210 may then call for conversation manager 230 to format a new question asking for a time to call back and/or a different number, such as a mobile phone number, to call the B-party. In such manner the original parameters/requirements for completing the CDT may be modified as necessary. It will be appreciated that depending on the configuration of server 200, such logic may also be implemented in communication task manager 220.

Some ending conditions may require conversation manager 230 to call the B-party back after a delay. For example, if a busy signal or no answer is detected, or if the B-party requests a later callback, manager 230 may have to call the B-party after an interval Accordingly, manager 230 may determine (step 360) whether delay conditions exist. If yes, then manager 230 may set (step 365) a timer for an appropriate delay and return control to step 310. Otherwise, conversation manager 230 may return (step 370) the B-party's response to communication task manager 220. Manager 220 may then forward the response to the A-party via I/O unit 215.

It will be appreciated that a B-party might be put off by the automated voice of a communications agent. In order to avoid a possible negative reaction and make this first impression a positive one, conversation manager 230 may include an introductory greeting as part of the “script” passed to the communications agent. Such an introductory greeting may be a recording of the A-party voice, introducing his agent. For example: “Hi this is John Smith and this is my delegate calling you. Please hang on”, followed by an automated voice: “Hi, this is the delegate of John”, followed by the rest of the interaction with an automated voice.

It will further be appreciated that this feature may be irrelevant for mass calls initiated by surveys or advertisers or sales people—because it may be unlikely that the B-party recipient has a direct relationship with the caller. However, in the case of the present invention, the B-party recipient may likely be acquainted with A-party and his voice. The introductory greeting of A-party may be recorded in a way similar to recording a greeting for a voicemail mailbox, by the A-party placing a call to a predefined number, the server calling A-party, or directly via application 150 or any add-on for PC etc. The recording procedure may allow a fully customizable greeting.

The recording procedure may suggest specific texts that may be optimized by the server operators to elicit the best reaction and provide the best overall experience. These could be proposed based on priority that may be culturally/demographically/geographically calibrated. Such that, for instance, in New York, there would be one set of priorities for sentences to be read out, while in London or California, different sentences would be proposed. In order to keep the phone interactions short and effective, Conversation manager 230 may include the introductory greeting only in the first few interactions with a specific B-party.

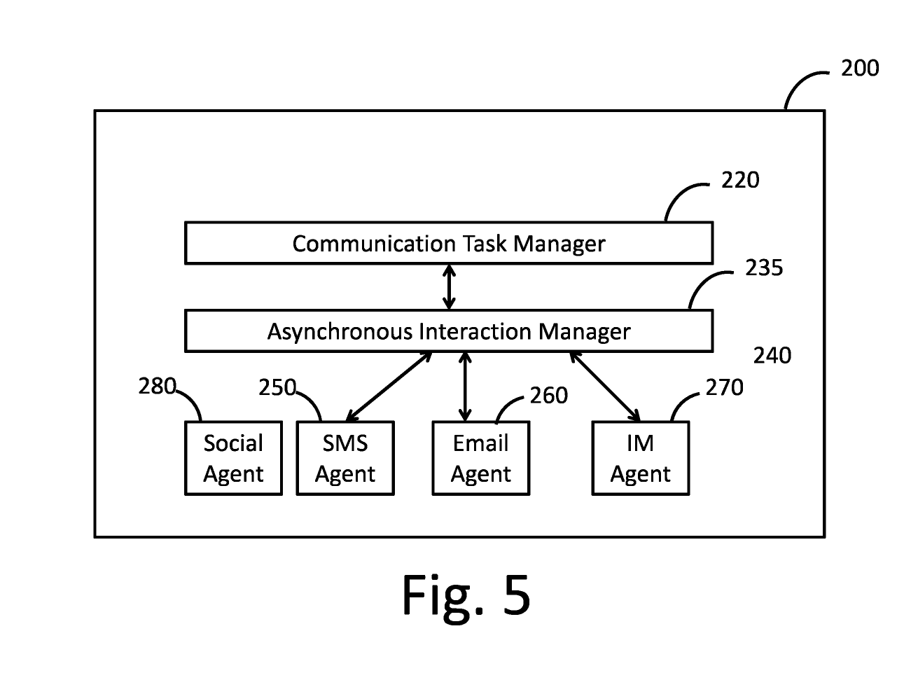

It will be appreciated that the A-party may use CDT server 200 to contact the B-party via non voice communication as well FIG. 5, to which reference is now made, illustrates an alternative preferred embodiment of CDT server 200 equipped for processing asynchronous CDTs. Server 200 may comprise communications task manager 220 as in the previous embodiment. However, when processing asynchronous CDTs, communications task manager 220 may employ asynchronous interaction manager 235 to manage communication with the B-party.

Asynchronous interaction manager 235 may manage communication with the B-party in a manner roughly analogous to that of conversation manager 230. However, instead of employing engine 240 for voice based communication, manager 235 may employ a variety of different asynchronous agents. For example, as shown in FIG. 5, server 200 may also comprise an SMS agent 250 for contacting the B-party via SMS, an email agent 260 for contacting the B-party via email, an IM agent 270 for contacting the B-party via instant messaging, and a social agent 280 for contacting the B-party via a social network such as Facebook, Twitter or Linkedin.

It will be appreciated that server 200 may use conversation manager 230 and asynchronous interaction manager 235 simultaneously. For example, conversation manager 230 may conduct a voice session with the B-party in regard to IM content that may be forwarded via asynchronous interaction manager 235 during the course of the conversation. Another example may include conducting a text chat over Skype or via the client application with a user (A-party), while recording his conversation with a service representative (B-party) over a voice channel.

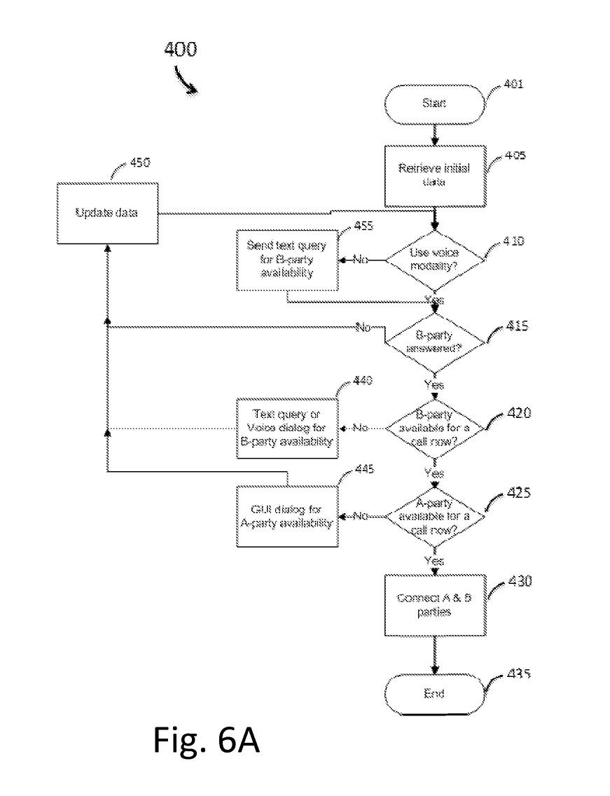

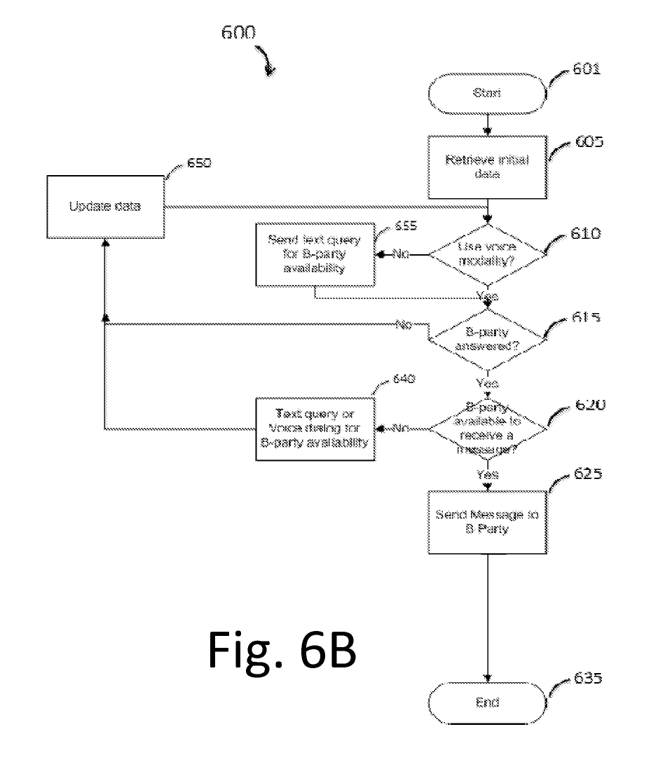

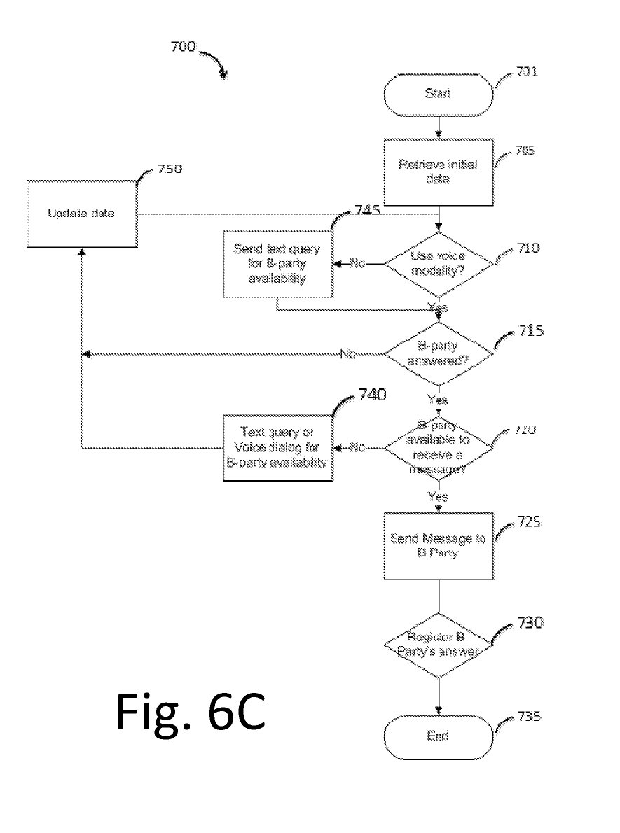

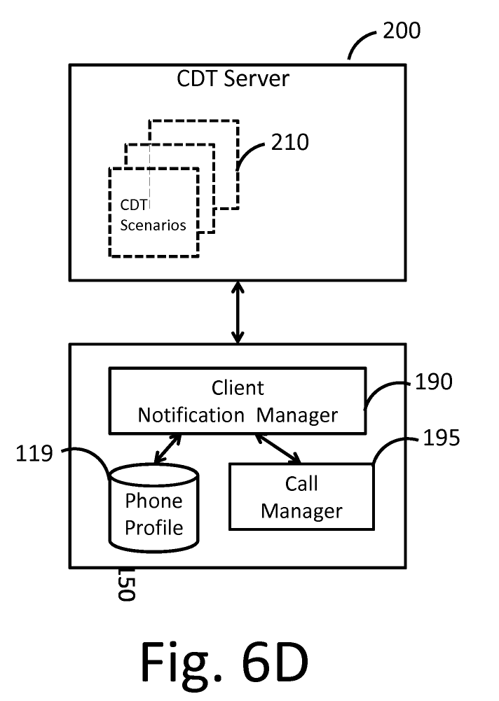

FIG. 6A, to which reference is now made, illustrates an exemplary process 400 by which communications task manager 220 may control and execute the exemplary CDT of “get the B-party on the phone” as discussed hereinabove. Manager 220 may start (step 401) when the CDT request may be received from CDT communicator 130. Communications task manager 220 may retrieve (step 405) initial data as required according to the definitions stored in the relevant scenario 210 (FIG. 1). Such data may include, for example, the modality to contact B-party (e.g. voice call or asynchronous communication), and the time constraints for execution. It will be appreciated that the details listed here are exemplary; CDT scenarios 210 may be configured to include a wide variety of information as necessary for a given CDT scenario. Furthermore, the information may have a variety of sources. For example, some information may be provided by the user, either at the time of entering/updating a CDT on the client application, or when indicating user preferences during a sign-up process. Some information may also be collected and/or derived by server 200 and/or server operators.

Based on the data retrieved in step 405, manager 220 may determine (step 410) whether the B-party should be contacted via a voice modality. If yes, the relevant details may be forwarded to conversation manager 230 for processing as described hereinabove. Otherwise, the details may be forwarded (step 410), for example, to asynchronous interaction manager 235.

Conversation manager 230 may attempt to communicate with the B-party and return the results to manager 220 as described hereinabove. Manager 220 may determine (step 415) if the B-party answered. If not, manager 220 may update (step 450) the details with the circumstances and processing may return to step 410. It will be appreciated that the results of step 410 may be affected by step 450. For example, the relevant scenario 210 may indicate that if a phone may not be answered, then an email may be sent instead.

If step 415 may indicate that the B-party answered, communications task manager 220 may analyze the returned response from manager 230 to determine (step 420) if the B-party is available to speak with the A-party. If not, communications task manager 220 may employ asynchronous interaction manager 235 to send (step 440) a text query to the B-party to inquire about future availability and then processing may continue to step 450 as described hereinabove. Otherwise, a GUI notification may be sent to device 110 to verify (step 425) that the A-party is available for the call.

If the result of step 425 is yes, or alternatively after a timeout, the A & B parties may be connected (step 430) for a phone call as described hereinabove, and the CDT process may end (step 435). Otherwise, communications task manager 220 may open (step 445) another GUI dialogue with the A-party to enquire regarding future availability and then processing may continue to step 450 as described hereinabove. In accordance with an alternative preferred embodiment, conversation manager 230 may also be used to query the availability of the A-party once the B-party may have expressed willingness to participate in the call.

It will be appreciated that FIG. 6A discloses an exemplary embodiment. The present invention includes a variety of CDT scenarios 210 that may be configured to provide CDT services as necessary. For example, a CDT scenario 210 may be defined such that manager 220 may use both managers 230 and 235 simultaneously to increase the chances of contacting the B-party. In another possible scenario, manager 220 may connect the A & B parties immediately after establishing willingness on the part of the B-party, without first contacting the A-party to verify availability. The present invention may provide a flexible framework for the definition of a multiplicity of such alternative scenarios.

FIGS. 6B and 6C, to which reference is now made, illustrate the processes by which two more exemplary scenarios 210 may be executed. FIG. 6B illustrates an “inform” CDT in which the B-party may be contacted to receive a message without need to initiate an actual conversation with the A-party. Process 600 may begin in a similar fashion to that of process 400. However, once the B-party answers (step 615) the next step may be to ask (step (620) whether or not the B-party may receive a message. Assuming the answer is yes, the message may be sent (step 625). It will be appreciated that process 600 may be implemented using either conversation manager 230 or asynchronous interaction manager 240, or both. Similarly, the communication agents employed may be configurable as well depending on the requirements. A typical use for such a CDT scenario may be to inform the B-party of a fact that does not require a response. For example, the A-party may just wish to let the B-party know that the plane is about to take off and therefore there is no need to try to respond.

Process 700 as illustrated in FIG. 6C may execute a “query” CDT. Process 700 may be similar to process 600 of FIG. 6 with the exception that an additional step may be added to receive an answer (step 730) to a question proposed as part of the message. A typical use for the process of FIG. 6C may be to confirm attendance at staff meeting. It will therefore be appreciated that the A-party may not only use a single CDT to communicate with multiple B-parties, but that the present invention may also provide detailed feedback to the A-party for each of the associated B-parties. It will further be appreciated that, as discussed hereinabove, application 115 may be a calendar application. The CDT of FIG. 6C may typically be launched from a calendar application.

As in the embodiment of FIG. 4, communications task manager 220 may modify the parameters/requirements for completing the CDT depending on the B-party's response. For example, process 300 may implement a CDT scenario 210 for verifying that the B-party received a fax from the A-party. If the response from the B-party may be “no”, than manager 220 may instruct manager 230/235 to verify the phone number of the fax machine so that the fax may be resent either manually and/or as an added feature through server 200.

Reference is now made to FIG. 6D which illustrates an exemplary preferred embodiment of application 150 in communication with CDT server 200. Application 150 may be configured to comprise a client notification manager 190, a call manager 195 and a phone profile 199. Phone profile 199 may be, for example, built-in functionality on a mobile communications device that enables a user to define different audio responses based on a selected profile, Common examples of phone profiles may be “general”, “silent”, “meeting”, “outdoors”, etc. As will be disclosed hereinbelow, such a configuration may be employed to verify the A-party's availability to talk to the B-party in order to complete the exemplary CDT as described hereinabove.

Client notification manager 190 may use several methods to determine the availability of A-party for actively participating in CDTs. For example, manager 190 may trigger application 150 to display a pop-up alert for the A-party before trying to attempt a call with a B-party, verifying that A-party is available at this time. The pop-up may incorporate UI controls to defer the execution of this CDT to a later time, or to edit/cancel the CDT.

Server 200 may also check with manager 190 or receive notification from manager 190 regarding information related to availability of A-party. Such information may be, for example, an ongoing call on the device, the destination number, and call termination event. Accordingly, manager 190 may interface with call manager 195 to check whether or not device 110 may be in use. It will be appreciated that call manager 195 may be any suitable functionality that may provide such information to manager 190.

Manager 190 may also check phone profile 199 for an indication of the A-party's current context. For example, manager 190 may notify server 200 to avoid initiating CDTs involving a phone call when the phone is in meeting profile.

The A-party may actively notify server 200 about his availability, for example by pressing a menu option for “I have 5 minutes” on application 150, which may update the server that it can initiate pending CDTs for this A-party during the next 5 minutes.

Application 150 may use calendar information to determine the A-party's current context as an indication of whether or not the A-party may be available for CDT participation. For example, when the calendar information shows that the A-party is in a meeting, application 150 may update server 200 that it should not try to initiate any CDTs involving a phone call with a B-party. Application 150 may also incorporate user preferences. For example A-party user #1 may prefer text-only communication during meetings, while user #2 may prefer no communication at all for most contacts, except specific contacts that may be allowed to call at any time. A-party may, for example, enter preferences via a preference screen of application 150, or via a web-interface to the server.

Some A-party users may prefer blocking predefined time periods for specific activities, such as reading emails during the first half hour of a working day. Such users may wish to set a calendar meetings dedicated for CDT execution. The application 150 or server 200 may initiate CDTs during these “CDT calendar meetings”.

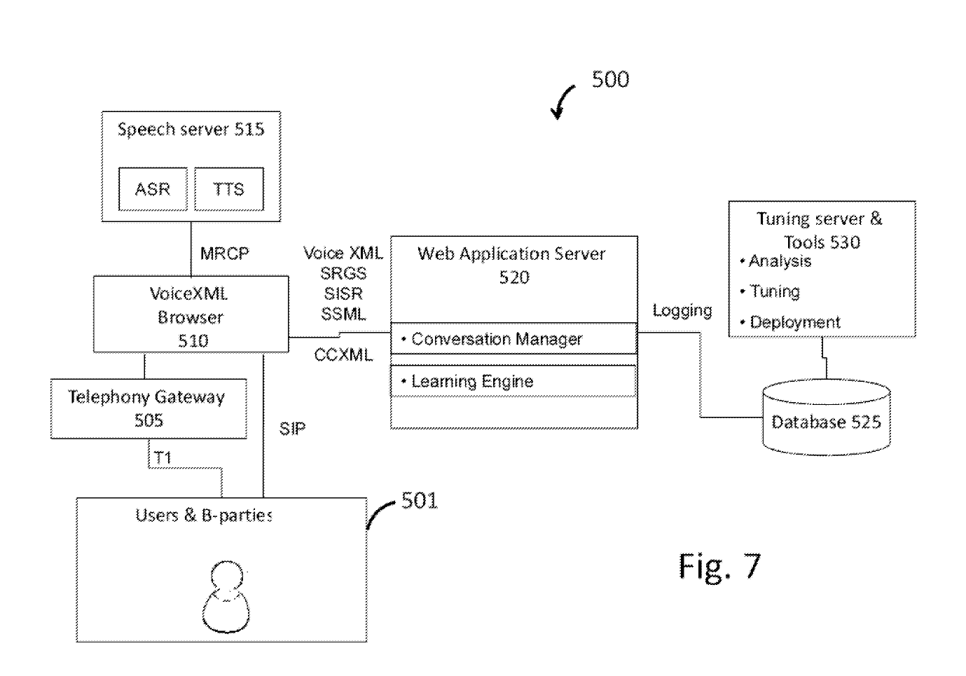

FIG. 7, to which reference is now made, illustrates an exemplary deployment 500 of the present invention with respect to voice dialog capabilities such as those employed within the context of the previous embodiments. A & B-parties may interface with the system through either regular PSTN or VoIP/SIP infrastructure 501. Regular PSTN calls may be routed through a telephony gateway 505 to a VoiceXML browser 510, and SIP calls may be routed directly to a VoiceXML browser 510. Telephony gateway 505 may be any commercially available and suitable gateway such as the Cisco 2800 series. VoiceXML browser 510 may be any commercially available and suitable VoiceXML browser such as the Voxeo prophecy system.

VoiceXML browser 510 may connect with a speech server 515 through the MRCP protocol. Speech server 515 may comprise an Automatic Speech Recognition (ASR) server and/or a Text To Speech (TTS) server. Such ASR & TTS servers may be commercially available from suppliers such as Nuance or Loquendo.

Web application server 520 may run the business logic as expressed in scenarios 210 as well as learning engine capabilities relevant for task scenarios and voice recognition. Web server 520 may communicate call control flows and dialog flows to VoiceXML browser 510 by sending CCXML and/or VoiceXML files and complementary files, such as audio files, TTS configuration, and grammar files in SRGS, or other relevant formats etc. Web server 520 may also log relevant activities in database 525. Tuning server 530 may be used for analysis and tuning task scenario information, voice dialogs, and other speech server parameters based on the logged information.

An exemplary listing of relevant W3C standards that may be used to implement the disclosed embodiments may include:

Voice Extensible Markup Language (VoiceXML) 2.1 http://www.w3.org/TR/voicexml21/;

Speech Recognition Grammar Specification (SRGS) Version 1.0 http://www.w3.org/TR/speech-grammar/;

Semantic Interpretation for Speech Recognition (SISR) Version 1.0 http://www.w3.org/TR/semantic-interpretation/; Speech Synthesis Markup Language (SSML) Version 1.0 http://www.w3.org/TR/speech-synthesis/; and

Voice Browser Call Control: CCXML Version 1.0 http://www.w3.org/TR/ccxml/.

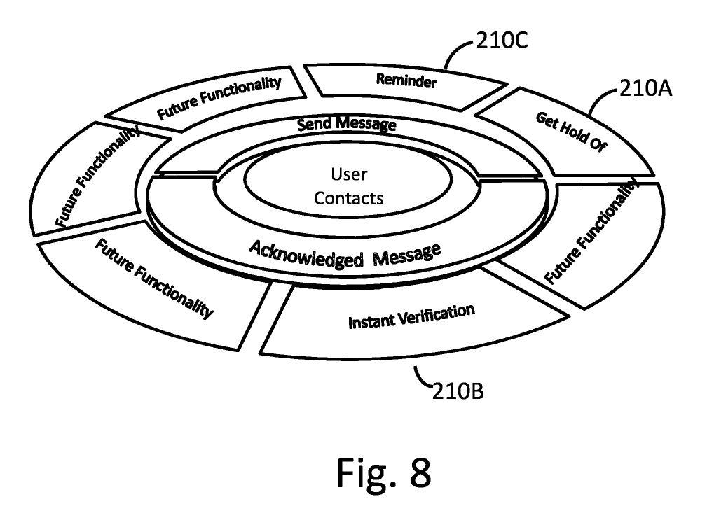

It will be appreciated that the present invention may provide a robust framework for servicing a wide range of CDT scenarios 210. Reference is now made to FIG. 8 which illustrates a framework 600 for future development of the system of the present invention. Framework 600 may comprise a core based on standard user contacts applications 115, a layer of client services such as communicator 130 that may request CDT services a and receive information regarding their status, and a layer of CDT server tasks embodied in CDT scenarios 210. It will be appreciated that applications 115 may represent any source of contact information that may be used as a basis for the definition of a CDT. Accordingly, the core of framework 600 may comprise a combination of standard built-in contact applications 115 such as that found in a Blackberry, standalone contact functionality to be packaged with or as part of CDT client application 150, or similar functionality on server 200 that may be accessed by web page or web service API.

In addition to CDT communicator 130, the client services layer may comprise services such as, for example, those included in CDT plug-in 120, CDT add-on 125, CDT client application 150 and/or web-based client applications. This layer may provide user access for the initiation, monitoring and modification of CDTs by users of the present invention.

One such exemplary CDT server task may be the “get hold of” CDT defined by scenario 210A as disclosed in the previous embodiments. Another exemplary CDT may be an instant verification CDT scenario 210B that entails calling a B-party, asking a simple yes or no question and reporting the answer to the A-party. Yet another exemplary CDT may be a reminder service defined according to a CDT scenario 210C. The A-party may initiate a reminder CDT to call the B-party at a certain hour with a reminder to do something.

It will be appreciated that framework 600 may be modular, such that future functionality scenarios 211 may be added as necessary. For example, framework 600 may also be leveraged to support ordering and purchasing tasks. The present invention may also include APIs that may be used by third party developers to further leverage framework 600 in order to service not yet envisioned CDTs as well.

It will be appreciated that the embodiments disclosed hereinabove are exemplary, the present invention may not be limited to any specific embodiment and may comprise the framework for additional functionality and embodiments as required. It will similarly be appreciated that unlike other prior art task managers, the present invention may be considered a task manager that actually does the tasks instead of just monitoring their progress.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method implementable on a computing device for brokering communication dependent tasks (CDTs), the method comprising: receiving at least an indication of a requested CDT from a user; associating said request with at least one pre-defined CDT scenario;
determining at least an appropriate time and means for communications for contacting at least one party based on said CDT scenario; and
contacting said party on behalf of said user.

2. The method according to claim 1 and wherein said at least one party is at least one of a human being and a computer service.

3. The method according to claim 1 and wherein said contacting is via use of at least one of speech and text dialog over one of voice and data communication channels.

4. The method according to claim 1 and wherein said contacting comprises scheduling communication with said party, wherein said scheduling is a product of negotiation with at least said party.

5. The method according to claim 3 and wherein said data communication channel is at least one of: a social network, an SMS, an email, an IM, and voice over IP.

6. The method according to claim 1 and also comprising connecting said user and said party in a telephone call, wherein said CDT scenario is to at least connect a telephone call between said user and said party.

7. The method according to claim 1 and wherein said CDT scenario is to query said party on behalf of said user.

8. The method according to claim 1 and wherein said CDT scenario is to inform said party regarding something on behalf of said user.

9. The method according to claim 1 and wherein said contacting comprises at least two means for communication.

10. The method according to claim 1 and wherein said contacting comprises:
presenting said party a question; interpreting a response received from said party;
determining whether or not said response indicates that an end condition for said contacting has been met;
modifying said presenting as necessary according to at least a result of said determining;
repeating said presenting, interpreting, determining and modifying until said end condition has been met; and
performing a next communication step on behalf of said user, wherein said next communication step is at least one of: scheduling another instance of said contacting, repeating said contacting with a different question, repeating said contacting with different said means for communications, forwarding at least an indication of said response to said user, and connecting said user and said party in a telephone call.

11. The method according to claim 10 and wherein said interpreting comprises at least one of speech recognition, speech understanding and text interpretation.

12. The method according to claim 1 and wherein said determining also comprises scheduling said contacting in accordance with at least one of a set of preferences associated with said user and said CDT scenario.

13. The method according to claim 12 and wherein said scheduling also comprises determining a desired context for said user.

14. The method according to claim 13 and wherein said desired context is at least one of a location, a phone profile configured on a device associated with said user, and a calendar entry on a calendar associated with said user.

15. A method implementable on a computing device for facilitating communication dependent tasks (CDTs), the method comprising:
defining at least one CDT scenario for a user, wherein said CDT scenario entails at least communication with a party to be contacted and wherein said communication is via at least one of voice and data;
requesting said CDT scenario to be performed in association with at least one specific said party; and
forwarding said requested CDT scenario to a CDT server for processing.

16. The method according to claim 15 and wherein said requesting is initiated on a communications device from within at least one of: a native contacts application, a native dialer application, a native phone application, a native call log application, and a native calendar application.

17. The method according to claim 15 and wherein said forwarding comprises user context updating, wherein said updating is at least one of:
providing location data from a location based service (LBS) on a device associated with said user;
providing an indication of a phone profile on a communications device associated with said user;
providing calendar information from a calendar associated with said user; and
providing presence indicating information from an application associated with said user.

18. A CDT brokerage server, implementable on a computing device, comprising:
an I/O unit to receive at least an indication of a requested CDT from a user;
a communication task manager to associate said request with at least one pre-defined CDT scenario;
a conversation manager to at least determine an appropriate time and communication means for contacting at least one party based on said CDT scenario; and
at least one communications agent to contact said party via said communication means on behalf of said user.

19. The server according to claim 18 and wherein said at least one party is at least one of a human being and a computer service.

20. The server according to claim 18 and wherein said at least one communications agent is configured to use of at least one of speech and text dialog over one of voice and data communication channels.

21. The server according to claim 18 and wherein said conversation manager comprises a schedule negotiator to negotiate a communication schedule with said party, wherein said communication schedule is a product of negotiation with at least said party.

22. The server according to claim 20 and wherein said data communication channel is at least one of: a social network, an SMS, an email, an IM, and voice over IP.

23. The server according to claim 18 and also comprising means for connecting said user and said party in a telephone call, wherein said CDT scenario is to at least connect a telephone call between said user and said party.

24. The server according to claim 18 and wherein said CDT scenario is to query said party on behalf of said user.

25. The server according to claim 18 and wherein said CDT scenario is to inform said party regarding something on behalf of said user.

26. The method according to claim 18 and wherein said conversation manager is configurable to employ multiple said communications agents for a single CDT.

27. The server according to claim 1 and wherein each said communications agent is configurable to provide at least the following actions:
to present said party a question;
to interpret a response received from said party;
to determine whether or not said response indicates that an end condition has been met;
to modify said presented question as necessary according to at least a determination of said response;
to repeat other configurable said actions until said end condition has been met; and
to perform a next communication step on behalf of said user, wherein said next communication step is at least one of: to schedule another attempt to contact, to present a different question, to present said question with a different said communications agent, to forward at least an indication of said response to said user, and to connect said user and said party in a telephone call.

28. The server according to claim 27 and wherein said communications agent comprises at least one of speech recognition, speech understanding and text interpretation.

29. The server according to claim 18 and wherein said conversation manager also comprises a scheduler to schedule said contacting in accordance with at least one of a set of preferences associated with said user and said CDT scenario.

30. The server according to claim 29 and wherein said scheduler also comprises a desired context determiner to determine a desired context for said user.

31. The method according to claim 30 and wherein said desired context is at least one of a location, a phone profile configured on a device associated with said user, and a calendar entry on a calendar associated with said user.

32. A communications device for facilitating communication dependent tasks (CDTs) comprising:
A CDT task manager to at least enable definition of at least one CDT scenario for a user, wherein said CDT scenario entails at least communication with a party to be contacted and wherein said communication is via at least one of voice and data; and
A CDT communicator to at least communicate a request to a CDT server for said CDT scenario to be performed in association with at least one specific said party.

33. The communications device according to claim 32 and also comprising: at least one of a contact application interface and a standalone contact database to at least provide contact information to be associated with said party to be contacted.

34. The communications device according to claim 33 and wherein said contact application interface facilitates said request from within at least one of: a native contacts application, a native dialer application, a native phone application, a native call log application, and a native calendar application.

35. The communications device according to claim 32 and also comprising a location based service (LBS) to provide an indication of a current context for said user.

36. The communications device according to claim 32 and also comprising a client notification manager to determine the availability of said user for active participation in a CDT.

37. The communications device according to claim 36 and wherein said client notification manager is configured to interface with at least one of:
a current phone profile on a communications device associated with said user;
a calendar associated with said user; and
a presence indicating application associated with said user.
